(19) United States
(12) Patent Application Publication
(10) Pub. No.: US 2007/0046049 A1
(43) Pub. Date: Mar. 1, 2007

(54) Manually assisted reaching apparatus

(76) Inventors: Bradley D. Gale, Columbus, IN (US); Trevor S. Brown, Salem, IN (US); Philip W. Burbrink, Columbus, IN (US)

Correspondence Address: BARNES & THORNBURG LLP, 11 SOUTH MERIDIAN, INDIANAPOLIS, IN, 46204, US

(21) Appl. No.: 11/213,159

(22) Filed: Aug. 26, 2005

(51) Int. Cl. B65G 7/12

(52) U.S. Cl. 294/16

(57) ABSTRACT

A manually assisted reaching apparatus includes a base, a reach-extender unit, an extension tube, and an actuator assembly. The extension tube is coupled to the base on one end and to the reach-extender unit on the other end to provide a user with an extensible reach for grasping distant or elevated objects.

### BACKGROUND

The present disclosure relates to reaching devices. More particularly, the present disclosure relates to manually assisted reaching devices. Reaching devices are used to grasp distant or elevated objects where an extensible reach may be desired.

### SUMMARY

According to the present disclosure, a manually assisted reaching apparatus includes a base, a reach-extender unit, an extension tube, and an actuator assembly. The extension tube is coupled to the base on one end and to the reach-extender unit on the other end to provide a user with an extensible reach for grasping distant or elevated objects.

The base includes a rod-retraction trigger, a hand grip, and a forearm support coupled to the hand grip. The reach-extender unit is configured having an openable and closable jaw assembly including a jaw support and a first and second opposable jaws coupled to the jaw support. The extension tube is configured to be coupled to the base to allow pivoting movement of the extension tube to move between a first use position in which the first and second jaws are arranged to pivot about a vertical axis and a second use position in which the first and second jaws are arranged to pivot about a horizontal axis.

The actuator assembly includes an actuator rod and a jaw lock. The actuator rod is coupled on a first end to the first and second jaws and coupled on a second end to the rod-retraction trigger to cause the actuator rod to retract toward the hand grip to cause the first and second jaws to move relative to the jaw support to assume a closed article-grasping position. The jaw lock is configured to cause the first and second jaws to maintain a compressive force against a grasped object so that a user does not have to maintain a continuous actuation force on the rod-retraction trigger when securing distant or elevated objects.

### BRIEF DESCRIPTION OF THE DRAWINGS

The detailed description particularly refers to the accompanying figures in which:

FIG. 1 is a perspective view of a reaching apparatus in accordance with the present disclosure, the reaching apparatus including a base and a reach-extender unit mounted for movement on the base from a first use position shown in FIG. 1 to a second use position shown in FIG. 2, the base including a hand grip and a forearm support coupled to the hand grip, and the reach-extender unit including an openable and closable jaw assembly and an extension tube interconnecting the jaw assembly and the hand grip;

FIG. 2 is a view similar to FIG. 1 showing rotation of the reach-extender unit relative to the base about an axis of rotation extending through the extension tube to assume the second use position;

FIG. 3 is an enlarged elevation view of a portion of the reaching apparatus of FIG. 10, with portions broken away, showing a user holding the base to raise and lower the reach-extender unit.

FIG. 4 is an exploded perspective view of the reaching apparatus of FIG. 1 showing (from top to bottom) an actuator rod, components comprising the base, the extension tube, formed to include a longitudinally extending passageway sized to receive the actuator rod therein, and components included in the jaw assembly;

FIG. 5 is a sectional view taken along line 5-5 of FIG. 2 showing first and second jaws moved relative to a jaw support to assume a “closed” article-grasping position by “inward” movement of an actuator rod included in the base and mounted to move back and forth in inward and outward directions in the extension tube;

FIG. 6 is a sectional view similar to FIG. 5 showing “outward” movement of the actuator rod in the extension tube to cause the first and second jaws to move relative to the jaw support to assume an “opened” article-releasing position adapted to receive an article therebetween;

FIGS. 7-10 show movement of components included in the reaching apparatus of FIG. 1 as a user operates the hand grip included in the base to move the first and second jaws from the opened article-releasing position shown in FIG. 5 toward the closed article-grasping position shown in FIG. 4;

FIG. 7 is an enlarged side elevation view of a portion of the reaching apparatus of FIG. 1, with portions broken away, showing normal arrangements of the components in the hand grip and the actuator rod in the extension tube to move the first and second jaws to assume the opened article-releasing position;

FIG. 8 is a side elevation view similar to FIG. 7 showing a user's fingers applying an actuation force to a rod-retraction trigger included in the hand grip (while the hand grip is unlocked) to cause the actuator rod to retract toward the hand grip causing the first and second jaws to move relative to the jaw support to assume the closed article-grasping position;

FIG. 9 is a side elevation view similar to FIG. 8 showing the user's fingers maintaining the actuation force on the rod-retraction trigger and the user's thumb simultaneously applying an actuation force to a jaw-lock trigger to move a jaw lock included in the hand grip from an unlocked position shown in FIGS. 6 and 7 to a locked position;

FIG. 10 is a side elevation view similar to FIG. 9 showing movement of the rod-retraction trigger under a gravity-bias force urging the hand grip to assume a normal at-rest position;

FIG. 11 is a perspective view of a second reaching apparatus contemplated by this disclosure, the reaching apparatus including a base and a reach-extender unit mounted for movement on the base from a first use position shown in FIG. 1 to a second use position shown in FIG. 2, the base including a hand grip and the reach-extender unit including an openable and closable jaw assembly, and an extension tube interconnecting the jaw assembly and the hand grip; and

FIG. 12 is a view similar to FIG. 11 showing rotation of the reach-extender unit relative to the base about an axis of rotation extending through the extension tube to assume the second use position.

### DETAILED DESCRIPTION

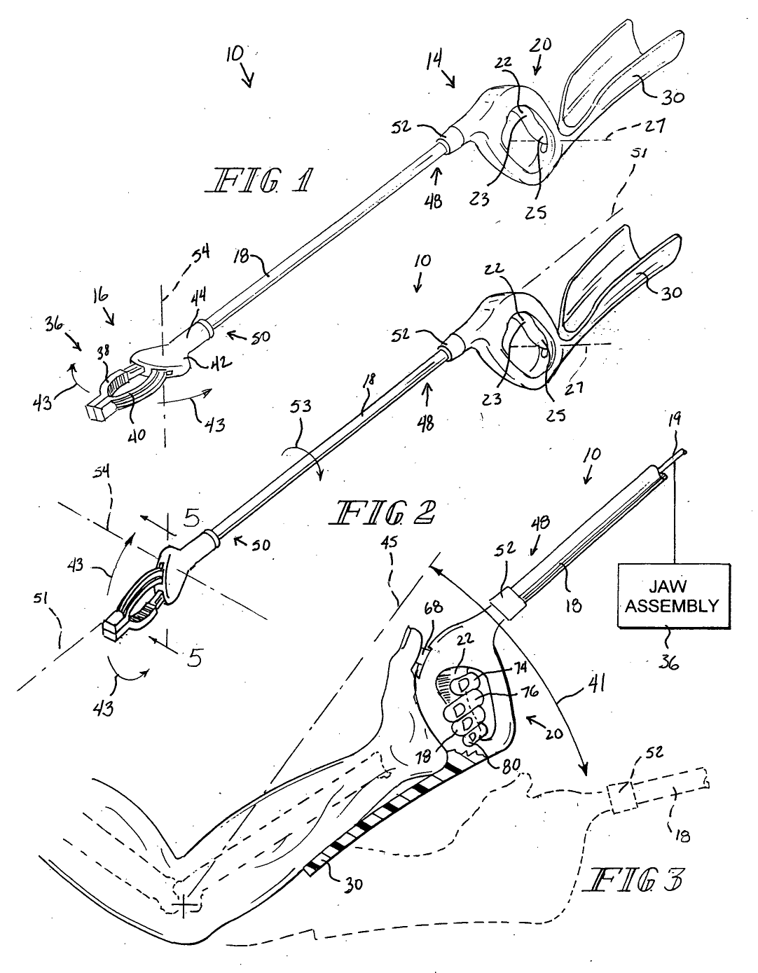

A reaching apparatus 10 is configured for grasping an object 12 such as a container (e.g., cans, bottles, bags, boxes) at a distance, or elevated, from a user, as shown, for example, in FIG. 1. Reaching apparatus 10 is portable and includes a base 14, a reach extender unit 16, an extension tube 18 coupled therebetween, and an actuator rod 19 extending through extension tube 18 to connect base 14 and reach extender unit 16.

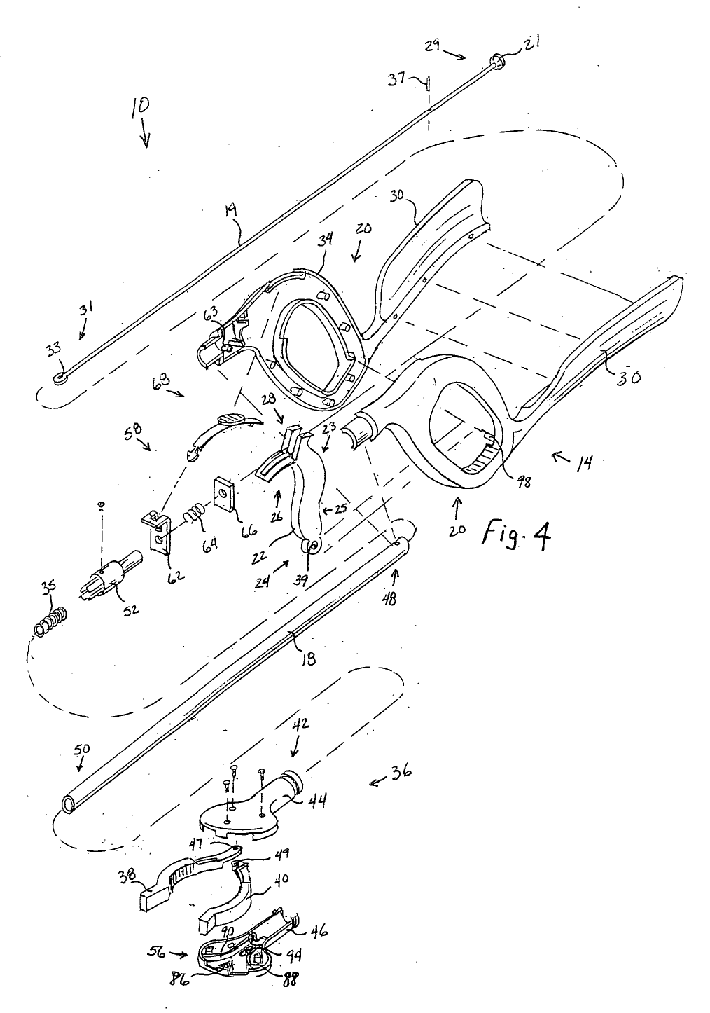

Referring now to FIG. 4, base 14 includes a hand grip 20, a rod-retraction trigger 22 coupled to hand grip 20 for pivotable movement therein, and a forearm support 30 coupled to hand grip 20 extending away from reach extender unit 16. Hand grip 20 is arranged within base 14 to receive a hand 17 of a user to establish a palm-forward orientation of hand 17, as shown best in FIG. 3. Illustratively, hand grip 20 includes a first portion 26 coupled to a second portion 28. First and second portions 26, 28 cooperate to form hand grip 20.

Referring now to FIGS. 1, 2, and 8, rod-retraction trigger 22 includes a first end 24 and a second end 26. First end 24 is coupled to hand grip 20 for pivotable movement about a pivot axis 27 between a first position where rod-retraction trigger 22 is biased toward reach extender unit 16 and a second position away from reach extender unit 16. Rod-retraction trigger 22 is configured having a wider upper portion 23 and a narrower lower portion 25 where wider upper portion 23 is wider than narrower lower portion 25. Wider upper portion 23 is configured to receive an index finger 74 and a middle finger 76 of the user and narrower lower portion 25 is configured to receive a ring finger 78 and a little finger 80 of the user. Thus, rod-retraction trigger 22 is configured to allow the index finger 74 and middle finger 76 of the user to exert a greater actuation force upon rod-retraction trigger 22 than is exerted by ring finger 78 and little finger 80.

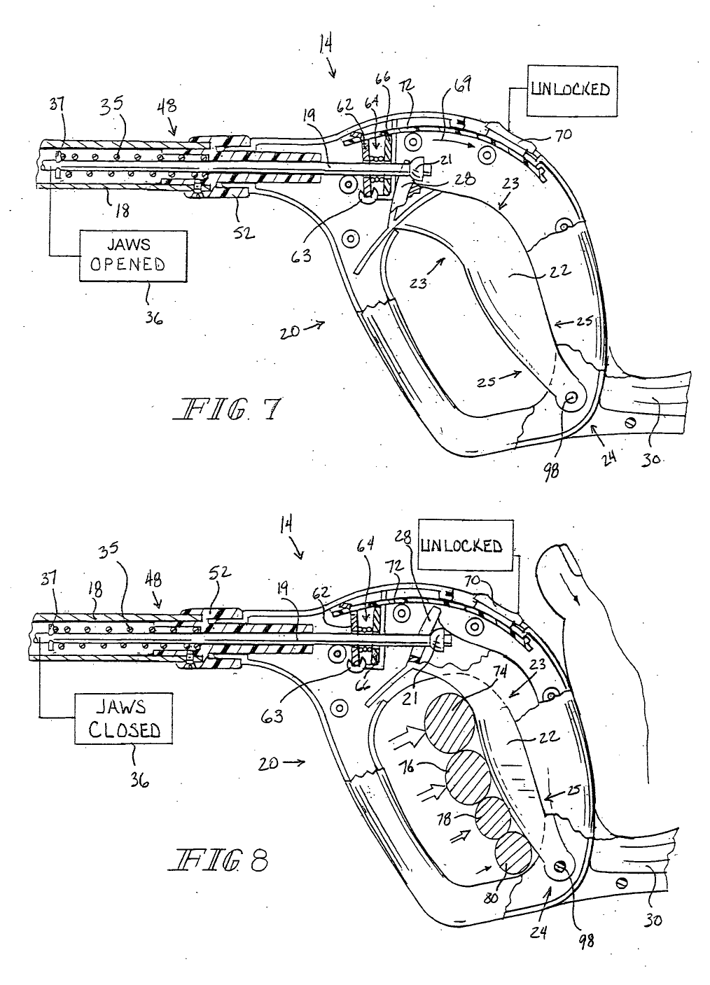

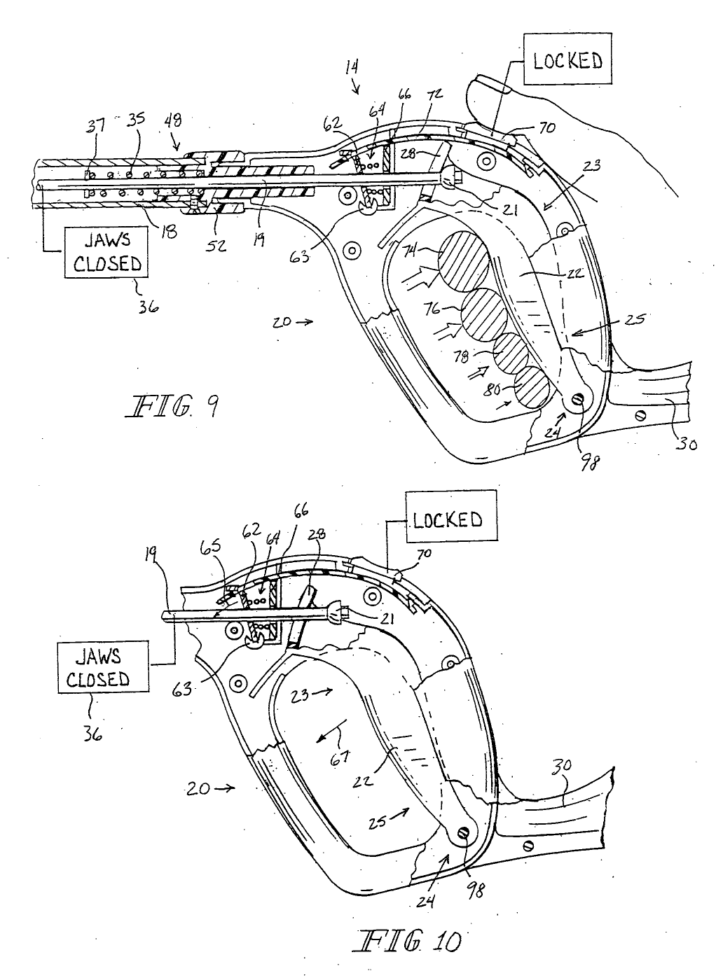

First end 24 is formed to include an aperture 39. Aperture 39 is configured to receive a portion of a pivot post 98 formed on base 14 for pivoting movement of trigger 22 about axis 27. Second end 26 of rod-retraction trigger 22 is formed to include a hooked portion 28, as shown in FIGS. 7 and 8.

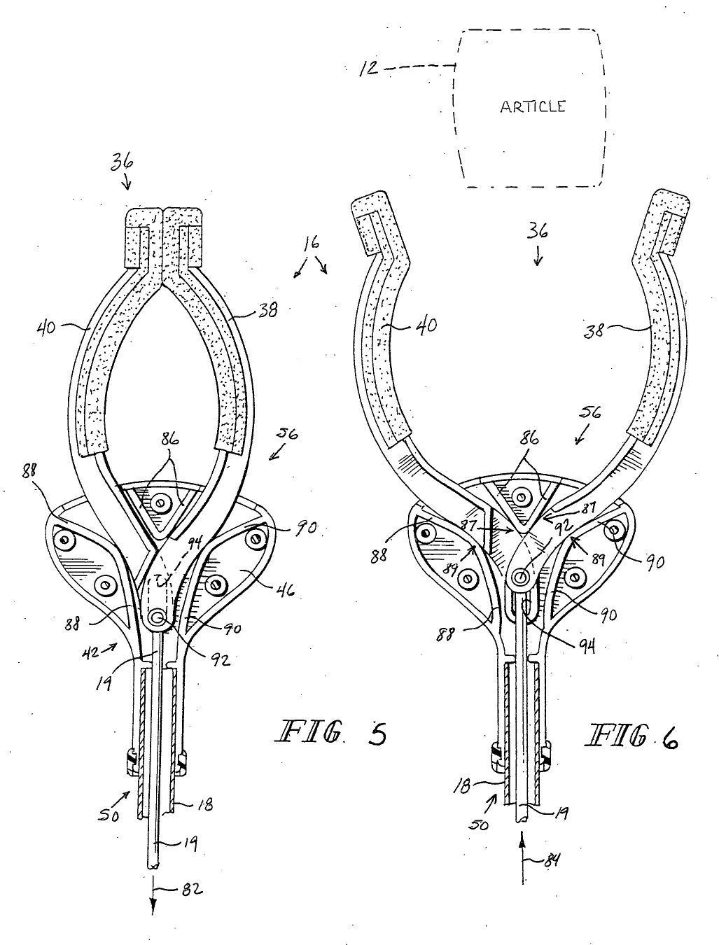

Hooked portion 28 is configured to be coupled to a first end 29 of actuator rod 19 for slidable movement of actuator rod 19 relative to base 18 and reach extender unit 16. First end 29 is formed to include a lug 21 configured to be received by hooked portion 28 to couple actuator rod 19 to rod-retraction trigger 22 for slidable movement of actuator rod 19 relative to base 14. Referring now to FIGS. 5 and 6, when rod-retraction trigger 22 is moved to the first position toward reach extender unit 16, actuator rod 19 moves in a direction 84 to cause first jaw 38 and second jaw 40 to pivot about axis 54 and move away from one another to an opened article-releasing position, and when rod-retraction trigger 22 is moved to the second position away from reach extender unit 16, actuator rod 19 moves in a direction 82 to cause first jaw 38 and second jaw 40 to pivot about axis 54 and move toward one another to a closed article-grasping position

Forearm support 30 is coupled to and extends away from base 14 in an opposite direction from extension tube 18. Forearm support 30 is configured to receive a portion of a forearm of the user when the hand of the user is received by hand grip 20, as shown, for example, in FIG. 12. During use of reaching apparatus 10, forearm support 30 forms a brace that is adapted to transmit, direct, resist, or support weight of an object 12 being grasped, to the forearm and away from the wrist joint of the user. Forearm support 30 cooperates with the forearm of the user to cause the forearm to act as a lever and an elbow joint of the user to act as a fulcrum to pivot about an axis 45, as shown, for example, in FIG. 12. This arrangement provides the user with a mechanical advantage when moving article 12 through an arc 41. Forearm support 30 is formed to provide brace means adapted to transmit, direct, resist, or support weight of object 12 being grasped to the forearm and away from the wrist joint of the user.

Reach extender unit 16 includes an openable and closable jaw assembly 36, a first jaw 38, a second jaw 40, and a jaw support 42, as shown best in FIGS. 5 and 6 First and second jaws 38, 40 are coupled to a second end 31 of actuator rod 19. Second end 31 is formed to include an aperture 33. Jaw 38 is formed to include an aperture 47. Second jaw 40 is formed to include an aperture 49. Apertures 47, 33, and 49 cooperate to receive a portion of a pivot pin 92 extending therethrough. First and second jaws 38, 40, second end 31, and pivot pin 92 cooperate to form pivot axis 54. Jaws 38, 40 are configured for pivotable movement toward and away from one another in a direction 43 about pivot axis 54 relative to jaw support 42 in response to movement of actuator rod 19 toward reach extender unit 16 in a direction 84 or away from reach extender unit 16 in a direction 82.

Actuator rod 19 further includes a bias member 35 arranged to receive a portion of actuator rod 19 therethrough and a keeper 37. Keeper 37 cooperates with bias member 35 to urge actuator rod 19 away from base 14 to cause jaws 38, 40 to assume the opened article-receiving position when reaching apparatus 10 is at rest. Illustratively, each jaw 38, 40 may be made of a non-slip material such as rubberized plastic.

Jaw support 42 includes a first portion 44 coupled to a second portion 46. Each portion 44, 46 is formed to include jaw movement guides 56 on an interior-facing surface of each portion 44, 46, as shown best in FIGS. 5 and 6. Jaw movement guides 56 cooperate to guide jaws 38, 40 to pivot toward one another in response to the actuation force being applied to rod-retraction trigger 22 to cause actuator rod 19 to move away from jaw support 42 toward base 14 and to pivot away from one another in response to the actuation force being applied to rod-retraction trigger 22 to cause actuator rod 19 to move toward jaw support 42 and away from base 14.

Jaw movement guides 56 include a V-shaped cam portion 86, a first side cam portion 88, a second side cam portion 90. V-shaped cam portion 86, first side cam portion 88, second side cam portion 90, and pivot pin guide channel 94 are all formed on an interior-facing surface of each portion 44, 46 of jaw support 42 and cooperate to form a Y-shaped guide channel 96 to receive first jaw 38 and second jaw 40 for pivotable and slidable movement therein.

Jaw support 42 further includes a pivot pin guide channel 94 formed on the interior-facing surface of each portion 44, 46 and being configured to receive an end portion of pivot pin 92 to guide and limit travel of pivot pin 92 within the bounds of guide channel 94. Thus, pivot pin guide channel 94 defines the extent of travel of actuator rod 19 in directions 82 and 84.

V-shaped cam portion 86 is configured to engage a convex portion 87 formed in each jaw 38, 40 to cause jaws 38, 40 to pivot about axis 54, and thus move away from one another, in response to the movement of actuator rod 19 in direction 84. First side cam portion 88 and second side cam portion 90 are configured having a convex shape and cooperate to engage an associated concave portion 89 formed in each jaw 38, 40 to cause jaws 38, 40 to pivot about axis 54, and thus move towards one another, in response to the movement of actuator rod 19 in direction 82

Extension tube 18 includes a first end 48 and a second end 50. First end 48 is coupled to a rotator collar 52. Rotator collar 52 is configured to be coupled to base 18 to allow the user to rotate extension tube 18 to cause reach extender unit 16 to rotate about ninety degrees in a direction 53. Referring now to FIGS. 1 and 2, when reach extender unit 16 is rotated about ninety degrees, pivot axis 54 is likewise rotated about an axis 51 from a generally vertical orientation to a generally horizontal orientation to cause jaws 38, 40 to move from a horizontally-oriented plane of operation to a vertically-oriented plane of operation. It may be desirable to move the jaw pivot orientation so that a user may grasp objects of varying dimensions.

Reaching apparatus 10 further comprises a lock assembly 58 coupled to base 14 including a jaw lock 60 coupled to base 14, a lock flange 62, a bias member 64, a bias member retainer 66, and a jaw-lock trigger 68. Lock flange 62, bias member 64, and bias member retainer 66 are formed to include an actuator-receiving aperture to receive a portion of actuator rod 19 therethrough. Jaw-lock trigger 68 includes an actuator tab 70 coupled to an arcuately-shaped connector 72. Arcuately-shaped connector 72 is coupled to lock flange 62. Lock flange 62 is pivotably coupled to a pivot post 63 formed on an interior surface of base 14 and configured to move between a first unlocked position where actuator rod 19 is able to move freely through lock flange 62 and a second locked position where lock flange 62 inhibits movement of actuator rod 19 through lock flange 62 by taking a bite on a portion of actuator rod 19.

As lock flange 62 is moved to the second locked position in a direction 65, jaws 38, 40 are configured to retain a static position corresponding to the position in which actuator rod 19 is held fast by lock flange 62. Therefore, lock assembly 58 allows the user to grasp an article, actuate lock assembly 58 to cause jaws 38, 40 to retain a compressive opposable force on the grasped article, and then release the actuation pressure on rod-retraction trigger 22 in a direction 67 while maintaining the grasp on the article.

To release the grasp of the article, the user reapplies the actuation force to rod-retraction trigger 22 while moving actuator tab 70 to the unlocked position in a direction 69 to cause lock flange 62 to release the bite on a portion of actuator rod 19 allowing rod 19 to move freely through lock flange 62. As the user then releases the actuation force on rod-retraction trigger 22 a corresponding reduction in the compressive opposable force exerted on the grasped article by jaws 38, 40 is reduced and the article can be released.

Extension tube 18, and rotator collar 52 provide means for coupling the reach-extender to the base. Wider upper portion 23 and narrower lower portion 25 also cooperate to provide means for actuating rod-retraction trigger 22 with index finger 74 and middle finger 76. Hand grip 20 is arranged to provide means for receiving the hand 17 of the user so that a palm-forward orientation of hand 17 is established. Jaw lock 60, lock flange 62, bias member 64, bias member retainer 66, and jaw-lock trigger 68 cooperate to form locking means for locking first jaw 38 and second jaw 40 in a fixed position.

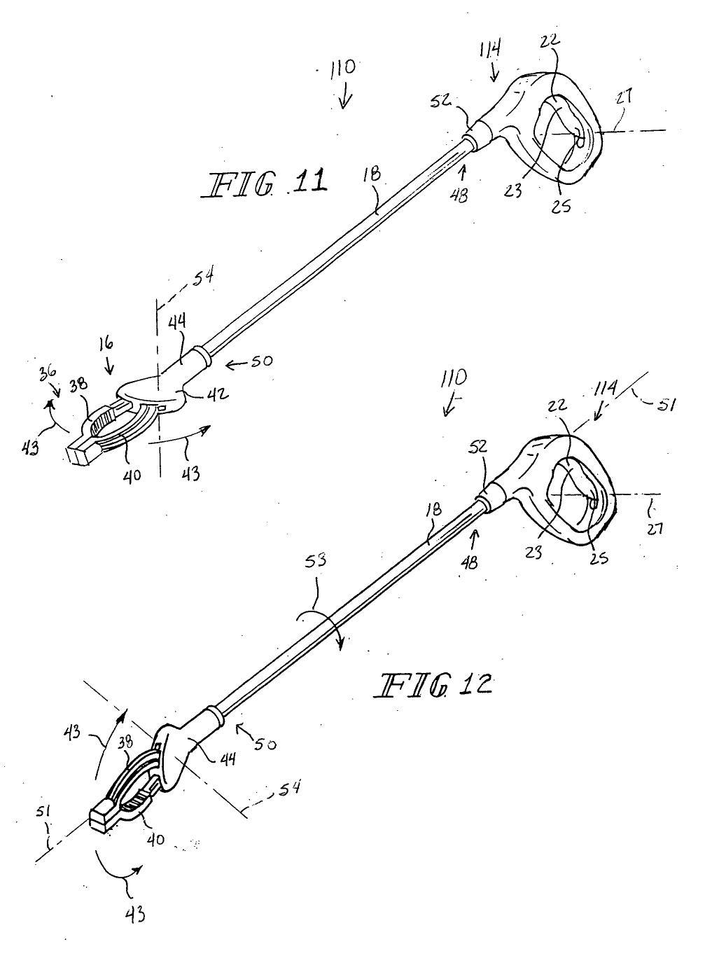

A second reaching apparatus 110 contemplated by this disclosure includes a base 114, the reach extender unit 16, the extension tube 18 coupled therebetween, and the actuator rod 19 extending through extension tube 18 to connect base 114 and reach extender unit 16. Referring now to FIGS. 11-12 base 114 includes the hand grip 20 and the rod-retraction trigger 22 coupled to hand grip 20 for pivotable movement therein.

1. A reaching apparatus comprising
a base including a hand grip and a rod-retraction trigger coupled to the hand grip, and a forearm support coupled to the hand grip,
a reach-extender unit including an openable and closable jaw assembly, the jaw assembly being configured to include a first and a second jaw coupled to a jaw support for pivotable movement toward and away from one another relative to the jaw support, and
means for coupling the reach-extender to the base so that, when the rod-retraction trigger is moved in a first direction, the first and second jaws to move toward one another relative to the jaw support to assume a closed article-grasping position to grasp and hold an article therebetween, and so that, when the rod-retraction trigger is moved in a second direction opposite to the first direction, the first and second jaws to move away from one another relative to the jaw support to assume an opened article-releasing position adapted to receive an article therebetween.

2. The reaching apparatus of claim 1, further comprising an actuator rod including a first end and a second end, and wherein the base further includes axle means coupled to the hand grip for supporting the rod-retraction trigger for pivotable movement about a pivot axis relative to the hand grip between a first neutral position causing the actuator rod to be extended away from the base and toward the jaw assembly, and a second position causing the actuator rod to be retracted into the base and away from the jaw assembly.

3. The reaching apparatus of claim 2, wherein the rod-retraction trigger is arranged to provide means for actuating the rod-retraction trigger with an index and a middle finger of a user so that the actuator rod is moved toward the base.

4. The reaching apparatus of claim 2, wherein the rod-retraction trigger includes a hook-shaped portion configured to be coupled to the first end of the actuator rod.

5. The reaching apparatus of claim 2, wherein the hand grip is arranged to provide means for receiving a hand of a user so that a palm-forward orientation of the hand is established.

6. The reaching apparatus of claim 1, wherein the forearm support is arranged to be coupled to the hand grip extending away from the reach-extender unit.

7. The reaching apparatus of claim 6, wherein the forearm support is configured to provide brace means for supporting an article held by the jaw assembly.

8. The reaching apparatus of claim 1, further comprising a jaw lock coupled to the base including a connector coupled to a lock flange, a lock bias member, a bias member retainer, and a jaw-lock trigger, and wherein the jaw lock is configured to cause the first and second jaws to maintain a compressive force against a grasped object in response to an actuation force being applied to the jaw-lock trigger.

9. The reaching apparatus of claim 8, wherein the lock flange, the bias member, and the bias member retainer are formed to include an actuator-receiving aperture to receive a portion of the actuator rod therethrough.

10. The reaching apparatus of claim 1, further comprising an actuator rod including a first end coupled to the rod-retraction trigger and a second end coupled to the first and second jaws.

11. The reaching apparatus of claim 10, wherein the jaw support is formed to include a jaw movement guide configured to guide the movement of the first and second jaws from the closed article-grasping position to grasp and hold the article therebetween to the opened article-releasing position adapted to receive the article therebetween.

12. The reaching apparatus of claim 10, wherein the second end is arranged to interconnect the first and second jaws to establish a jaw pivot axis.

13. The reaching apparatus of claim 12, wherein the jaw support includes a first portion and a second portion and the first and second portions cooperate to receive the first and second jaws for pivotable movement therein.

14. The reaching apparatus of claim 1, wherein the coupling means includes an extension tube having a first end coupled to the base and a second end coupled to the reach extender unit.

15. The reaching apparatus of claim 14, wherein the extension tube is hollow and is configured to receive the actuator rod therethrough.

16. The reaching apparatus of claim 15, wherein the extension tube is configured to be coupled to the base for pivotable movement between a first use position where the first and second jaws pivot about a vertical axis and a second use position where the first and second jaws pivot about a horizontal axis.

17. The reaching apparatus of claim 15, further comprising a rotator collar including a first end and a second end, and wherein the first end is rotatably coupled to the base and the second end is fixably coupled to the extension tube to allow the extension tube to rotate relative to the base between a first use position where the first and second jaws pivot about a vertical axis and a second use position where the first and second jaws pivot about a horizontal axis.

18. The reaching apparatus of claim 15, further comprising a bias member coupled to the rotator collar and arranged to receive a portion of the actuator rod therethrough, and wherein the bias member is configured to urge the actuator rod away from the base to cause the first and second jaws to move to the opened article-releasing position.

19. A reaching apparatus comprising
a base including a hand grip, a rod-retraction trigger, and a forearm support coupled to the hand grip,
a reach-extender unit having an openable and closable jaw assembly, the jaw assembly being configured to include first and second jaws coupled to a jaw support for pivotable movement toward and away from one another relative to the jaw support,
an actuator rod, and
an extension tube through which the actuator rod extends, the tube including a first end portion and a second end portion, the base being rotatably coupled to the first end portion and the reach-extender being coupled to the second end portion.

20. The reaching apparatus of claim 19, further comprising an actuator rod including a first end and a second end, and wherein the base further includes axle means coupled to the hand grip for supporting the rod-retraction trigger for pivotable movement about a pivot axis relative to the hand grip between a first position causing the actuator rod to be extended away from the base and toward the jaw assembly and a second position causing the actuator rod to be retracted into the base and away from the jaw assembly.

21. The reaching apparatus of claim 20, wherein the rod-retraction trigger is arranged to provide means for actuating the rod-retraction trigger with a user's index and middle finger so that the actuator rod is moved toward the base.

22. The reaching apparatus of claim 20, wherein the rod-retraction trigger includes a hook-shaped portion configured to be coupled to the first end of the actuator rod.

23. The reaching apparatus of claim 20, wherein the hand grip is arranged to provide means for receiving a user's hand so that a palm-forward orientation of the user's hand is established.

24. The reaching apparatus of claim 20, wherein the forearm support is arranged to be coupled to the hand grip extending away from the reach-extender unit.

25. The reaching apparatus of claim 19, wherein the forearm support is configured to provide brace means for supporting an article held by the jaw assembly.

26. The reaching apparatus of claim 19, further comprising jaw locking means formed in the hand grip for locking the first and second jaws in a fixed position.

27. The reaching apparatus of 26, wherein the base further includes a rotator collar coupled to the hand grip on one end and to the first end of the extension tube on the other, the rotator collar is configured to allow the extension tube to rotate relative to the base between a first use position where the first and second jaws pivot about a vertical axis and a second use position where the first and second jaws pivot about a horizontal axis.

28. A reaching apparatus comprising
a base including a hand grip, a rod-retraction trigger coupled to an actuator rod, and a forearm support coupled to the hand grip, the actuator rod being configured to move relative to the base,
a reach-extender unit having an openable and closable jaw assembly including first and second jaws coupled to a jaw support,
a jaw lock coupled to the base, and
an extension unit including an extension tube having a first end and a second end, and an actuator rod having a first end and a second end extending therethrough, the extension tube being rotatably coupled to the base on the first end and coupled to the jaw support on the second end, the actuator rod being coupled on a first end to the first and second jaws and coupled on a second end to the rod-retraction trigger and being arranged for movement in a first direction away from the first and second jaws to cause the first and second jaws to move toward one another relative to the jaw support to assume a closed article-grasping position to grasp and hold an article therebetween and arranged for movement in a second direction, opposite to the first direction, toward the first and second jaws to cause the first and second jaws to move away from one another relative to the jaw support to assume an opened article-releasing position adapted to receive an article therebetween.

29. The reaching apparatus of claim 28, further comprising jaw locking means formed in the hand grip for locking the first and second jaws in a fixed position.

30. The reaching apparatus of claim 28, wherein the forearm support is configured to provide brace means for supporting an article held by the jaw assembly.
